(19) United States
(12) Patent Application Publication
(10) Pub. No.: US 2009/0084079 A1
(43) Pub. Date: Apr. 2, 2009

(54) Device for preparing grass for mowing

(76) Inventor: Wayne Raymond Grohs, Guilford, CT (US)

Correspondence Address: Wayne R. Grohs, 88 Old Pent Road, Durham, CT, 06422, US

(21) Appl. No.: 12/283,545

(22) Filed: Sep. 12, 2008

Related U.S. Application Data
(60) Provisional application No. 60/993,493, filed on Sep. 12, 2007.

(51) Int. Cl. A01D 75/00; A01D 34/82; A01D 43/00

(52) U.S. Cl. 56/1; 56/17.5

(57) ABSTRACT

A device for mowing grass includes an axle attachable to a lawn mower aft of a wheel of the lawn mower and forward of a grass cutting blade of the lawn mower; a plurality of tines extending from the axle, at least a portion of the tines being engagable with leaves of grass on a ground surface; and a wheel attached to the first end of the axle and being engagable with and rotatable on the ground surface. Upon operation of the device for preparing grass, a rotation of the axle causes the tines to engage the leaves of grass and direct the leaves into substantially vertical positions in preparation for being cut by the grass cutting blade of the lawn mower.

### CROSS REFERENCE TO RELATED APPLICATION

This application claims the benefit of U.S. Provisional Patent Application Ser. No. 60/993,493, filed on Sep. 12, 2007, the contents of which are incorporated herein by reference in their entirety.

### TECHNICAL FIELD

The present invention relates to grass mowing and, more particularly, to a device that causes leaves of grass that have been flattened, matted, or otherwise arranged into a substantially horizontal configuration to stand erect in preparation for mowing.

### BACKGROUND OF THE INVENTION

Various types of grasses have been developed over the years and have been planted for use as ground covers. Such ground covers are not simply aesthetic or ornamental when planted as a lawn, they also reduce erosion, inhibit the growth of unsightly and/or noxious weeds, and provide surfaces that can be used for recreational purposes. Different varieties of grasses require varying amounts of sun, shade, water, and fertilization to thrive, and many are engineered for particular climates or for particular uses. For example, fescues, ryes, bluegrasses, and the like are well suited to northern climes in which the temperatures are cool to moderate, while Zoysia, Bermuda, and the like are more suited to warmer areas. Most any type of grass requires periodic maintenance in the form of trimming or mowing.

Methods for maintaining lawns over the years have evolved from rolling or pressing grass down into dense mats using heaving rollers, to cutting the individual leaves using reel-type mowers, to cutting the individual leaves using blades (as in modern lawn mowers) that rotate at high speeds. In a modern mower, such rotating blades are typically mounted under a deck and driven by a motor. In modern push mowers, the deck is supported by wheels and has a handle attached for ease of pushing or guiding the mower. In modern riding mowers, the deck can either be supported by wheels or attached to a frame or similar structure (or both).

In modern riding mowers, an operator can sit or stand on the mower and control the mowing operation. Such riding mowers typically employ pneumatic tires to evenly and efficiently distribute the weight of the operator and mower over the footprint of the mower. However, because such mowers typically utilize internal combustion engines to drive the rotation of the blade(s), the mowers are quite heavy, often weighing several hundreds of pounds. The operator may add considerably more weight. Even with pneumatic tires and lightweight materials such as plastics, a riding mower generally flattens down the grass as it is operated on a lawn in a lawn mowing operation.

Because the deck and the associated rotating blade(s) are generally mounted behind front wheels and forward of rear wheels, the front wheels often press down, flatten, mat, or otherwise cause the individual leaves to assume a substantially horizontal position as the mower is operated. When the grass is wet, thick, or both, the individual leaves generally do not spring back up after the tire rolls forward and before the leaves can be engaged by the rotating blade(s) of the mower. Accordingly, the leaves that are pressed down by the front wheels are too low to be properly cut when the rotating blade(s) subsequently pass over them. Once these flattened leaves do right themselves into substantially vertical orientations shortly thereafter, they impart an unsightly appearance to the lawn, often giving the impression that the rotating blade(s) of the mower were not properly sharpened and simply knocked the individual leaves down or that areas of the lawn were missed altogether in the mowing operation.

What is needed is a device that causes the individual leaves of grass that are flattened by the wheels of a lawn mower ahead of the rotating blade(s) of the mower to be rendered into substantially vertical or erect positions in preparation for proper cutting, thereby allowing the leaves of grass of a mowed lawn to be substantially uniform in height.

### SUMMARY OF THE INVENTION

In one aspect, the present invention is directed to a device for preparing grass for mowing. The device includes an axle attachable to a lawn mower aft of a wheel of the lawn mower and forward of a grass cutting blade of the lawn mower; a plurality of tines extending from the axle, at least a portion of the tines being engagable with leaves of grass on a ground surface; and a wheel attached to the axle and being engagable with and rotatable on the ground surface. Upon operation of the device, a rotation of the axle causes the tines to engage the leaves of grass and direct the leaves into substantially vertical positions in preparation for being cut by the grass cutting blade of the lawn mower.

In another aspect, the present invention is directed to a device for raising leaves of grass into substantially vertical orientations in preparation for mowing. This device includes an axle mounted to a lawn mower and positioned substantially parallel to a ground surface, the axle being located intermediate a front tire and a grass cutting blade of the lawn mower; a wheel supporting the axle at a point along a length of the axle; and a plurality of tines extending from the axle. The tines are engagable with leaves of grass in substantially horizontal positions to raise the leaves into substantially vertical positions.

In another aspect, the present invention is directed to a lawn mower. This lawn mower includes a grass cutting blade rotatably mounted under a deck housing, the deck housing being positioned aft of a tire of the lawn mower; an axle horizontally mounted relative to a ground surface, the axle being positioned aft of the tire and forward of the grass cutting blade; and a plurality of tines extending from the axle. Upon rolling of the tire on the ground surface, the axle rotates and the tines engage leaves of grass in substantially horizontal positions and cause the leaves to assume substantially erect positions in preparation for being cut by the grass cutting blade.

### BRIEF DESCRIPTION OF THE FIGURES

FIG. 1 is perspective view of one embodiment of the device of the present invention.

FIG. 2 is a plan view of the device of FIG. 1 mounted on a riding lawn mower.

FIG. 3 is a perspective view of another embodiment of the device of the present invention.

FIG. 4 is a side sectional view of one embodiment of a spring-biased device of the present invention.

FIG. 5 is a plan view of the device of FIG. 4.

FIG. 6 is a side sectional view of one embodiment of the device of the present invention showing one configuration of tines.

FIG. 7 is a side sectional view of another embodiment of the device of the present invention showing another configuration of tines.

### DETAILED DESCRIPTION

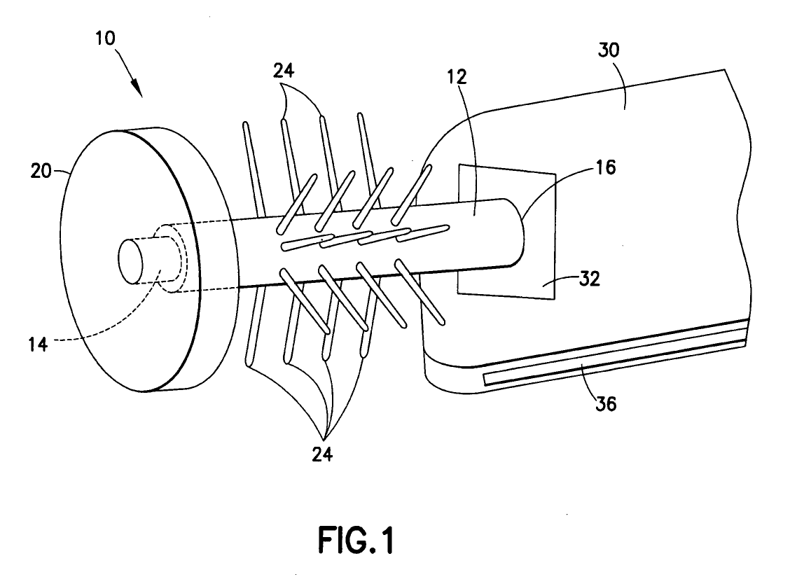

Referring to FIG. 1, a device for preparing grass for mowing is shown generally at 10 and is hereinafter referred to as “device 10.” In operation, device 10 causes leaves of grass that have been pressed down or are otherwise assuming a substantially horizontal position to approximate a substantially vertical or erect position in preparation for being cut. Although it is anticipated that the leaves of grass are substantially horizontally oriented as a result of the grass being run over by a tire of a lawn mower (particularly when the grass is thick, wet, or both), the leaves may be substantially horizontally oriented for any other reason. Furthermore, although it is anticipated that the grass is substantially horizontally oriented due to the rolling of a tire of a riding lawn mower, the grass may be flattened or pressed down due to the rolling of a tire or wheel of any type of lawn mower or wheeled vehicle.

In one embodiment, the device 10 includes an axle 12 having a first end 14 and a second end 16. A wheel 20 is connected at the first end 14 of the axle 12. A plurality of tines 24 are located on the axle 12, each tine extending radially from the axle. In one embodiment, the second end 16 of the axle 12 is connected to a deck 30 of a riding lawn mower under which is housed at least one cutting blade 36. The present invention is not limited in this regard, and the axle can be connected to the riding lawn mower at a point other than the deck. Also, the wheel 20 can be anywhere along the length of the axle 12 and is not limited to being at the first end 14. When the axle 12 is connected to the deck or other point of the riding lawn mower, the axle is substantially parallel to a ground surface and can rotate when the wheel 20 is engaged with and rolled on the ground surface.

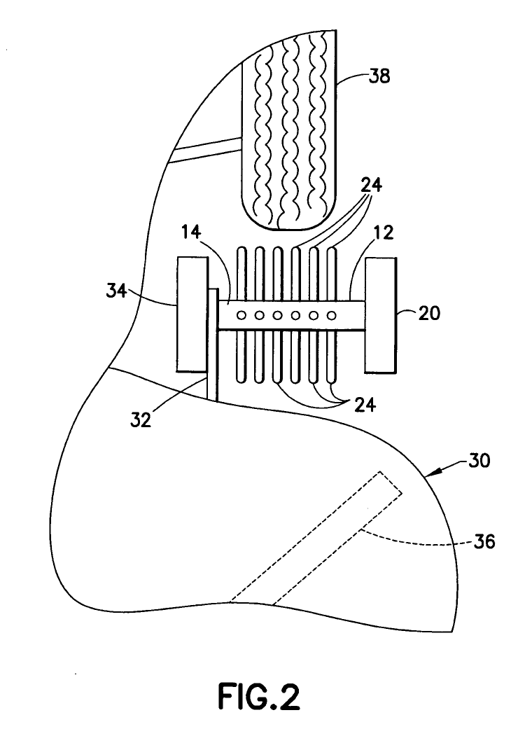

Referring now to FIG. 2, the axle 12 is connected to the deck 30 using any suitable means. As shown, a support tab 32 extends from the deck 30 to provide a surface on which a deck wheel 34 can be mounted to enable the deck to ride on the ground surface during operation of the riding lawn mower. The second end 14 of the axle 12 is rotatably connected to at least one of the support tab 32 and the deck wheel 34. When the wheel 20 turns, the axle 12 turns correspondingly. During the operation of the riding lawn mower and the device 10, the wheel 20 engages the ground surface and rotates, thereby causing the axle 12 to rotate. As the axle 12 rotates, the tines 24 engage grass that is laying down or is otherwise substantially horizontally oriented and draw the leaves thereof into substantially vertical orientations for cutting by the cutting blade 36. Although only one device 10 is shown, additional devices can be located on the mower, for example, behind other tires and forward of the grass cutting blades.

The tines 24 extend from the outer surface of the axle 12 such that the tine/axle assembly has a cross sectional diameter that approximately corresponds to the diameter of the wheel 20. Preferably, the tines 24 extend from the axle 12 a distance that is slightly less than the diameter of the wheel 20. In doing so, the weight of the deck 30 may be borne by the wheel 20 (and possibly the deck wheel 34), and the tines 24 are more likely to engage the grass without being driven into the ground surface, thereby more efficiently drawing the blades of the substantially horizontally oriented grass into the substantially vertical orientation.

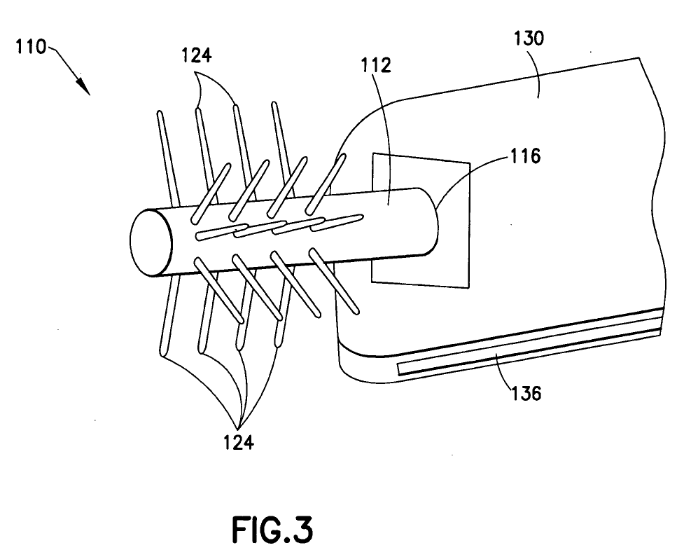

Referring now to FIG. 3, another embodiment of the device is shown generally at 110 and is hereinafter referred to as “device 110.” The device 110 includes a rotatable axle 112 that is connected at one end 116 thereof to a deck 130 of a lawn mower under which at least one grass cutting blade 136 is housed. The axle 112 is mounted behind the front tire and forward of the deck 130 and rotates at the connection of the one end 116 via any suitable means such as a bearing. Tines 124 extend from the axle 112 such that the ends thereof engage the grass without being driven into the ground surface. Rotation of the axle 112 allows the tines 124 to engage grass that is substantially horizontally oriented to draw the leaves thereof up into substantially vertical orientations.

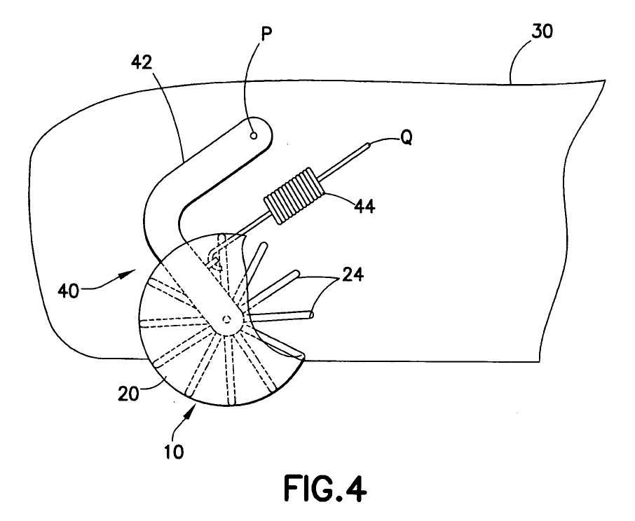

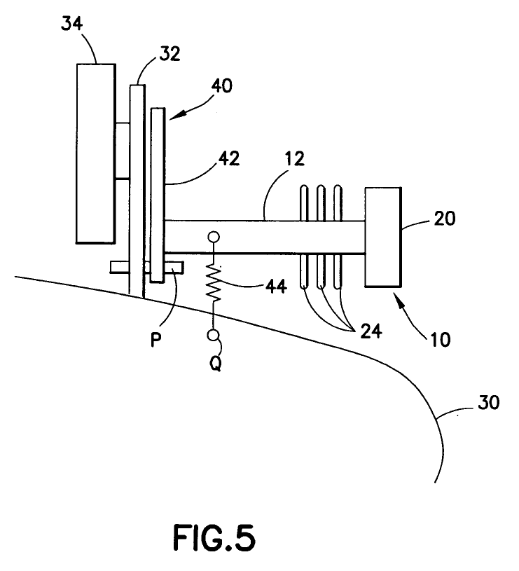

In any embodiment of the device, the device may be urged in the direction of the ground surface using a spring mechanism. Referring now to FIGS. 4 and 5, a spring-biased arm assembly 40 is attached to any suitable point such as the deck 30 or the support tab 32 on which the deck wheel 34 is mounted. The spring-biased arm assembly 40 comprises an arm 42 pivotally connected proximate one end thereof (pivot point P) to the deck 30 or the support tab 32 on which the deck wheel 34 is mounted. The arm 42 or the axle 12 is further connected to an anchor point Q on the deck 30 or other suitable point using a spring 44. The device 10 (or any variation thereof) is attached to the arm 42 such that the wheel 20 (if used) can engage and roll along the ground surface and such that the tines 24 suitably engage the grass. The arm 42 may be shaped and the spring 44 may be attached to the arm and the anchor point Q to allow the spring-biased arm assembly 40 to be “cammed over.” By camming over the arm 42, the spring-biased arm assembly 40 can be engaged or disengaged, thereby removing the tines 24 from contact with the grass, at the discretion of the user.

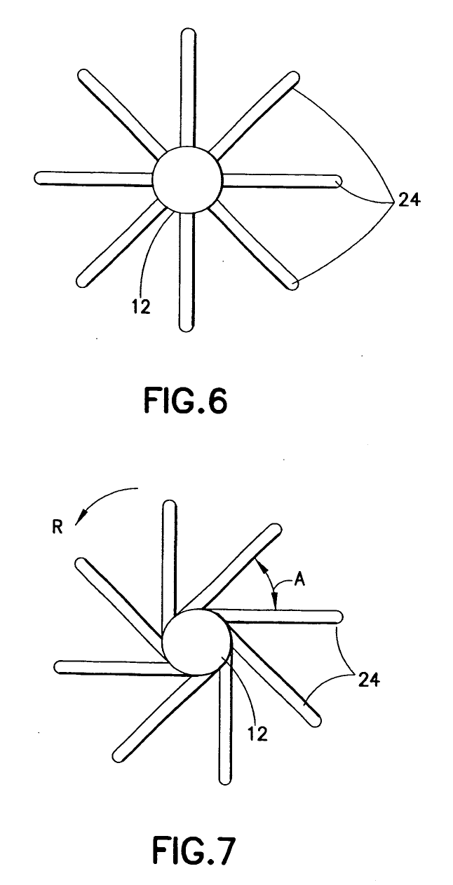

Referring now to FIG. 6, the tines 24 extend substantially orthogonally from the outer surface of the axle 12. The present invention is not limited in this regard, however, as the tines 24 may extend from the outer surface of the axle at an angle A, as shown for example in FIG. 7, to effect a more or less aggressive drawing of the leaves of grass into the substantially vertical orientation. In FIG. 7, a direction of rotation of the axle 12 is shown as R such that the tines 24 are raked back to effect a less aggressive drawing of the leaves of flattened grass into the substantially vertical orientation.

Referring to all of the Figures, the tines 24 can be metal, fiberglass, plastic, nylon, wood, combinations of the foregoing, or the like. In one embodiment, the tines 24 can be rigid (substantially inflexible) to aggressively comb the grass to the substantially vertical orientation. In another embodiment, the tines 24 can be flexible to provide a less aggressive drawing of the leaves of the flattened grass into the substantially vertical orientation. In still other embodiments, the tines 24 can be either rigid or flexible and flexibly attached to the axle 12.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A device for preparing grass for mowing, said device comprising:
an axle having a first end and a second end, said second end of said axle being attachable to a lawn mower aft of a wheel of said lawn mower and forward of a grass cutting blade of said lawn mower;
a plurality of tines extending from said axle, at least a portion of said tines being engagable with leaves of grass on a ground surface; and
a wheel attached to said first end of said axle and being engagable with and rotatable on said ground surface;
wherein upon operation of said device for preparing grass, a rotation of said axle causes said tines to engage said leaves of grass and direct said leaves of grass into substantially vertical positions in preparation for being cut by said grass cutting blade of said lawn mower.

2. The device of claim 1, wherein said axle is attached to a deck of said lawn mower.

3. The device of claim 1, wherein said axle is attached to a support tab extending from a deck of said lawn mower.

4. The device of claim 1, wherein said axle is attached to a spring-biased assembly pivotally attached to a deck of said lawn mower.

5. The device of claim 4, wherein said spring-biased assembly comprises,
an arm pivotally connected to said deck, and
a spring connected to said arm and an anchor point,
wherein a configuration of said arm and said spring allow said arm to be selectively positioned to cause said plurality of tines to be one of engaged and disengaged with said leaves of grass.

6. The device of claim 1, wherein said tines extend substantially orthogonally from an outer surface of said axle.

7. The device of claim 1, wherein said tines extend from an outer surface of said axle at an angle.

8. The device of claim 1, wherein said tines are flexible.

9. The device of claim 1, wherein said tines are rigid.

10. The device of claim 1, wherein said tines are flexibly attached to said axle.

11. The device of claim 1, wherein said tines extend from an outer surface of said axle a distance that is less than a diameter of said wheel.

12. A device for raising blades of grass into substantially vertical orientations in preparation for mowing by a lawn mower, said device comprising:
an axle mounted to said lawn mower and positioned substantially parallel to a ground surface, said axle being located intermediate a front tire and a grass cutting blade of said lawn mower;
a wheel supporting said axle at a point along a length of said axle; and
a plurality of tines extending from said axle;
wherein said tines are engagable with leaves of grass in substantially horizontal positions to raise said leaves of grass into substantially vertical positions.

13. The device of claim 12, further comprising a biasing assembly configured to urge said tines into said grass.

14. The device of claim 13, wherein said biasing assembly comprises an arm pivotally connected to said lawn mower and from which said axle extends, said arm being pivotal between an engaged position in which said tines are engaged with said leaves of grass and a disengaged position in which said tines are disengaged from said leaves of grass.

15. The device of claim 14, further comprising a spring connected to said biasing assembly to pivot said arm from said engaged position to said disengaged position.

16. The device of claim 12, wherein said tines extend substantially orthogonally from an outer surface of said axle.

17. The device of claim 12, wherein said tines extend from an outer surface of said axle at an angle.

18. A lawn mower comprising:
a grass cutting blade rotatably mounted under a deck housing, said deck housing being positioned aft of a tire of said lawn mower;
an axle horizontally mounted relative to a ground surface and on said deck housing, said axle being positioned aft of said tire and forward of said grass cutting blade; and
a plurality of tines extending from said axle;
wherein upon rolling of said tire on said ground surface, said axle rotates and said tines engage leaves of grass in substantially horizontal positions and cause said leaves of grass to assume substantially erect positions in preparation for being cut by said grass cutting blade.

19. The lawn mower of claim 18, wherein said axle is urged in the direction of said ground surface by a spring.

20. The lawn mower of claim 18, further comprising a wheel located on said axle, said wheel being configured to drive said axle upon the rolling of said wheel on said ground surface in response to a forward rolling movement of said tire on said ground surface.
